(19) United States
(12) Patent Application Publication
(10) Pub. No.: US 2025/0278544 A1
(43) Pub. Date: Sep. 4, 2025

(54) FAULT ATTACK SIMULATION

(71) Applicant: OPTIMA DESIGN AUTOMATION LTD., Nazareth (IL)

(72) Inventors: Jamil Raja MAZZAWI, Nazareth (IL); CV Sesha SAI KUMAR, Bangalore (IL); Ayman Kamil MOUALLEM, Mi'ilya (IL); Fares JARAISY, Nazareth (IL); Nagam KASSIS, Jadeidi-Makr (IL)

(21) Appl. No.: 18/859,014

(22) PCT Filed: Apr. 27, 2023
(86) PCT No.: PCT/IL2023/050430

§ 371 Date: Oct. 22, 2024

Related U.S. Application Data
(60) Provisional application No. 63/363,749, filed on Apr. 28, 2022.

(51) Int. Cl. G06F 30/3312; G06F 30/398; G06F 119/02; G06F 119/12

(52) U.S. Cl. CPC G06F 30/3312; G06F 30/398; G06F 2119/02; G06F 2119/12

(57) ABSTRACT

A method, system and apparatus for fault attack simulation. A circuit design and a fault attack simulation model defining characteristic of a multi-hit attack to be simulated in the circuit are obtained. The fault attack simulation model defines at least: a number of hits during the multi-hit attack, a time window in which the multi-hit attack is simulated, and a list of potentially attacked circuit elements of the circuit during the multi-hit attack. Based on the fault attack simulation model, a plurality of fault attacks adhering to the fault attack simulation are generated. Each generated fault attack includes a plurality of hits occurring during the time window and with respect to the list of potentially attacked circuit elements. The generated fault attacks are simulated using a hardware simulator that simulates the design of the circuit. The results of the simulation are outputted to the user.

### CROSS-REFERENCE TO RELATED APPLICATION

This application is a non-provisional of and claims the benefit of U.S. Provisional Application No. 63/363,749 filed Apr. 28, 2022, entitled “Fault Attack Simulation”, which is hereby incorporated by reference in its entirety without giving rise to disavowment.

### TECHNICAL FIELD

The present disclosure relates to circuit design in general, and to verification of a circuit design, in particular.

### BACKGROUND

The design process of a circuit involves planning the design of the circuit and performing verification to ensure that the circuit operates reliably and meets the required specifications. Verification may be performed with respect to both logical and physical designs. It involves testing and verifying that the design meets the required specifications and operates correctly.

Logical design, also known as register-transfer level (RTL) design, is the process of creating a high-level abstract representation of a circuit's functionality. In RTL design, the designer describes the behavior of the circuit using a hardware description language (HDL), such as Verilog or VHDL. The RTL design defines the circuit's input and output ports, as well as the internal logic blocks that are necessary to implement the desired functionality, including combinational gates, also referred to herein as “gates”, and memory elements, also referred to herein as “flops” (e.g., flip-flops, latches, or the like). The RTL design may be simulated to ensure that the circuit behaves as expected and meets the functional requirements.

Physical design, on the other hand, is the process of translating the logical design into an actual physical circuit. This involves placing and routing the circuit elements, such as gates, flops, and wires, on a physical chip layout. The physical design also involves ensuring that the circuit meets timing and power constraints and optimizing the circuit for performance, power, and area.

In order to shorten the development time of a circuit, functional verification may be performed prior to having a physical design and relying based on the functional design.

### BRIEF SUMMARY

One exemplary embodiment of the disclosed subject matter is a method, apparatus or system. The method comprising: obtaining a design of a circuit, wherein the circuit comprises circuit elements that include gates, flops and wires; obtaining a fault attack simulation model defining characteristic of a multi-hit attack to be simulated in the circuit, the fault attack simulation model defines at least: a number of hits during the multi-hit attack, a time window in which the multi-hit attack is simulated, and a list of potentially attacked circuit elements during the multi-hit attack, the list of potentially attacked circuit elements is a subset of the circuit elements. The method further comprises: automatically generating, based on the fault attack simulation model, a plurality of fault attacks adhering to the fault attack simulation, wherein each fault attack of the plurality of fault attacks includes a plurality of hits occurring during the time window and with respect to the list of potentially attacked circuit elements, wherein a number of hits in the plurality of hits corresponds to the number of hits defined by the fault attack simulation model. The method further comprises for each fault attack of the plurality of fault attacks, simulating the fault attack on the design of the circuit, wherein said simulating is performed using a hardware simulator simulating the design of the circuit. The method further comprises outputting result of said simulating to a user.

Optionally, the fault attack simulation model further defining a type of fault occurring in a hit, wherein the type of fault is selected from a group consisting of: a single event upset, a stuck-at fault, and a bridging-fault.

Optionally, the fault attack simulation model is a pulse-based fault attack simulation model, wherein the pulse-based fault attack simulation model includes a target location of a pulse attack, wherein the target location of the pulse attack defines the list of potentially attacked circuit elements.

Optionally, the design is a physical design of the circuit that defines physical placement of the circuit elements, wherein the target location is a physical location in the physical design of the circuit, wherein the method further comprises: determining a radius of the pulse attack; determining a pulse attacked region based on the physical location and the radius of the pulse attack; and identifying circuit elements that are within the pulse attacked region, whereby defining the list of potentially attacked circuit elements.

Optionally, the pulse-based fault attack simulation model includes a pulse intensity property, wherein said determining a radius of the pulse attack is determined based on a pulse intensity property.

Optionally, the pulse-based fault attack simulation model includes a pulse intensity property, wherein the number of hits during the multi-hit attack is determined based on the pulse intensity property.

Optionally, the design is a logical design, wherein the target location is a target circuit element that is selected from the circuit elements, wherein the method further comprises: determining the list of potentially attacked circuit elements based on logical proximity to the target circuit element.

Optionally, said determining the list of potentially attacked circuit elements comprises: performing forward and backward reachability analysis from the target circuit element.

Optionally, the forward and backward reachability analysis is performed based on cycle-based distance from the target circuit element.

Optionally, the pulse attack is at least one of: a laser attack and an electromagnetic (EM) attack.

Optionally, the pulse-based fault attack simulation model defines a first hit type for gates that are included in the list of potentially attacked circuit elements, wherein the pulse-based fault attack simulation model defines a second hit type for flops that are included in the list of potentially attacked circuit elements.

Optionally, the fault attack simulation model is a timing-based fault attack simulation model, wherein the timing-based fault attack simulation model is related to a timing-based fault attack that is configured to affect timing in which values of one or more flops are registered, wherein the list of potentially attacked circuit elements consists of the one or more flops.

Optionally, the timing-based fault attack is at least one of a voltage glitching attack and a clock glitching attack.

Optionally, the one or more flops that constitute the list of potentially attacked circuit elements is determined based on a critical timing path in the circuit design.

Optionally, the one or more flops that constitute the list of potentially attacked circuit elements is determined based on an estimated time budget of a combinational logic that drives the one or more flops.

Optionally, the list of potentially attacked circuit elements is determined based on an exclusion rule, the exclusion rule excludes elements based on secure asset information analysis of the design of the circuit.

Optionally, the secure asset information analysis comprises: obtaining one or more secure circuit elements, the one or more secure circuit elements are circuit elements that are considered as secure assets; and classifying the circuit elements based on respective relationship to the one or more circuit elements.

Optionally, said classifying comprises classifying each element as being at least one of: a load of the one or more secure circuit elements; a driver of the one or more secure circuit elements; and unrelated to the one or more secure circuit elements.

Optionally, the secure asset information analysis is performed with respect to one or more secure circuit elements, wherein the exclusion rule excludes circuit elements that are classified as unrelated to one or more secure circuit elements.

Optionally, the method comprises obtaining one or more user instructions defining strobe signals, wherein the strobe signals are defined based on a change with respect to a hit-free execution of the design of the circuit; wherein said simulating comprises evaluating values of the strobe signals; and wherein the result of said simulating is determined based on the values of the strobe signals.

Optionally, the strobe signals comprise a failure strobe, wherein the failure strobe is indicative of a successful simulated attack, wherein the result of said simulating includes an indication of a number of successful simulated attacks out of a total number of attempted simulated attacks.

Optionally, the strobe signals comprise a detection strobe, wherein the detection strobe is indicative of a successful detection of a simulated attack by an on-chip detection mechanism, wherein the result of said simulating includes an indication of a number of successful detections of attempted simulated attacks.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A shows an illustration of a trace, in accordance with some exemplary embodiments of the subject matter;

FIGS. 1B-1E show illustrations of multi-hit fault attack, in accordance with some exemplary embodiments of the subject matter;

FIG. 2 shows an illustration of Secure Asset Information (SAI)-based classification, in accordance with some exemplary embodiments of the subject matter;

FIG. 3 illustrates a laser attack in a physical design, in accordance with the disclosed subject matter;

FIG. 4 illustrates a laser attack in a logical design, in accordance with the disclosed subject matter;

FIG. 5A shows a flowchart diagram of a method, in accordance with some exemplary embodiments of the disclosed subject matter;

FIG. 5B shows a flowchart diagram of a method, in accordance with some exemplary embodiments of the disclosed subject matter; and

FIG. 6 shows an illustration of a screen showing the output of the fault attack simulation, in accordance with some exemplary embodiments of the disclosed subject matter.

### DETAILED DESCRIPTION

In the present disclosure the term “signal” refers to an element of a circuit design which receives a value. The signal may be any wire in the design, such as but not limited to, input, output, output of a memory element, input of a memory element, output of a gate, or the like.

In the present disclosure the term “memory element” or “flop” refers to any element of a circuit which retains data over different cycles, including but not limited to a flip flop, a register, a latch, a counter, a digital element having the capability to retain its value, or the like.

One technical problem dealt with by the disclosed subject matter is verifying and identifying weaknesses in a circuit design. In some cases, it may be desired to verify that the design is not susceptible to attacks. The Common Weakness Enumeration (CWE™) published by the MITRE™ corporation identifies potential weaknesses that can be exploited by hackers attempting to hack a circuit. For example, “CWE-1332: Improper Handling of Faults that Lead to Instruction Skips” is a weakness that can be exploited in such a manner. Attackers can use fault injection techniques to alter the operating conditions of hardware so that security critical instructions are skipped more frequently or more reliably than they would in a “natural” setting. As another example, defects in the form of “CWE-1248: Semiconductor Defects in Hardware Logic with Security-Sensitive Implications” may manifest as faults on chip-internal signals or registers, have the effect of inputs, outputs, or intermediate signals being always 0 or always 1, and do not switch as expected. Weakness “CWE-1247: Improper Protection Against Voltage and Clock Glitches” relates to improper protection against attacks such as voltage glitches and clock glitches that an attacker may employ in an attempt to compromise the system. Weakness “CWE-1319: Improper Protection against Electromagnetic Fault Injection (EM-FI)” relates to cases in which devices are susceptible to electromagnetic fault injection attacks, causing device internal information to be compromised or security mechanisms to be bypassed. As additional examples, related weakness may also include “CWE-1334: Unauthorized Error Injection Can Degrade Hardware Redundancy”, “CWE-1256: Improper Restriction of Software Interfaces to Hardware Features”, “CWE-1261: Improper Handling of Single Event Upsets”, “CWE-1255: Comparison Logic is Vulnerable to Power Side-Channel Attacks”, or the like. It may be desired to perform verification in an attempt to discover such weakness, as well as other security-related weaknesses.

It may be desired to enable verification as early as possible in the design process. In some cases, it may be desired to conduct such verification in with respect to the logical design, such as based on the RTL design alone. Additionally, or alternatively, some aspects of the verification may be performed after physical design is concluded.

Generally, attacks are done by hackers in lab conditions. Attackers inject faults on real/physical chips using different means, such as laser beam, electromagnetic (EM) radiation, changing the voltage the chips are working with, changing the clock frequency, or the like. Such means can cause the chip to malfunction, or to cause faults inside the chip. For example, a flop may not sample the correct data and provide an incorrect value; a signal value of a gate, a wire, or flop may be flipped (e.g., 0 instead of 1, or vice versa); a permeant fault in the chip may manifest, e.g., stuck-at-0, stuck-at-1, or the like. The goal of the attackers that the faults they injected, will cause the protection mechanism inside the chip to malfunction and certain secret data (referred to Secret Assets (SA)) that are inside the chip is leaked outside and could be captured by the hackers using side-channel methods. SAs may enable the design (also referred to as Design Under Test, or DUT) to perform many functionalities, including obtaining access to the service network that they are part of, for example: to access a mobile network, be able to decrypt conditional access media, to access a bank's remote banking server; offering security services to the users, such as: secure storage and access control to user passwords, licenses, or loyalty data, encrypt of removable storage data such as hard disks or USB memory sticks, allow remote access to, and secure communication with, a company network; ensuring their own operational integrity, through: booting from authenticated and encrypted boot software, running only authenticated programs, securely storing device-specific data such as configurations and feature enablement settings, operational parameters (e.g., radio transmitter settings), or the like.

A naive solution to such a need may be to simulate hits in a circuit. However, if the hits are generated randomly and without any focus, they may not be an adequate representation of a potential attack. For example, the attacker may focus her attention only to specific portions of the design. As another example, the attacker may utilize different means which may dictate potential affected portions of the design.

There is a need to simulate fault attacks prior to the fabrication of the design. In some cases, the simulation of a logical design may be useful. In other cases, it may be desired to simulate a physical design.

One solution may be to provide a fault simulation engine. The fault simulation engine may utilize a hardware simulator, applicable to logical or physical designs, and used to simulate the DUT's operation when a fault attack is being carried out. The simulation may be implemented using any commercial simulator. The simulation may be implemented by forcing specific values for specific signals, thereby emulating a fault. In some cases, a simulator that can be used may be the simulator described in U.S. Pat. No. 10,025,895, entitled “Circuit Simulation Using a Recording of Reference Execution”, which is hereby incorporated by reference in its entirety.

In some exemplary embodiments, the disclosed subject matter may utilize a fault attack simulation model. The fault attack simulation model may model the fault attack. The fault attack may be a multi-hit attack that includes several hits within a single execution. The several hits may occur in the same signal at different cycles. Additionally, or alternatively, the several hits may occur in different signals at the same cycle. Additionally, or alternatively, the several hits may occur in different signals at different cycles.

In some exemplary embodiments, the fault attack simulation model may define, directly or indirectly, different characteristics of the fault attack. As an example, the model may define a number of hits. In some cases, a precise number may be defined. In other cases, a range of numbers (e.g., between 100 and 200 hits) may be provided. In some cases, the fault attack simulation model may define a type of fault that occurs in each hit. The fault may be, for example, bit flip, single event upset, single bit upset, stuck-at fault, bridging-fault, or the like. In some exemplary embodiments, the fault attack simulation model may define, directly or indirectly, a time window in which the attack occurs. The time window may be defined as a range of cycles in which the attack will be simulated. Such a time window is representative of the time in which the hacker is assumed to be attempting to attack the DUT. In some cases, the time window may depend on properties of the attack means. For example, an attack duration of a laser pulse, the intensity of the laser, and other properties of the laser-based attack may affect the length of time window (e.g., 100 cycles, 200 cycles, or the like). In some cases, the attack may be based on multi-pulse attack, and a set of sub-windows having non-attacked gaps in between may be defined. As an example, a set of sub-windows of 100 cycles duration and with 200 cycles gaps may be defined (e.g., cycles 200-300, cycles 500-600, cycles 800-900). In other cases, the duration of the gap may be non-constant. In some cases, the duration of the sub-windows may be different. The model may define, directly or indirectly, a list of potentially attacked circuit elements, listing circuit elements, such as wires, flops, gates, or the like, that may be affected by the attack. The list may be a sub-set, potentially substantial sub-set of relative small portion of the circuit elements of the design, thereby enabling focused simulation of the attack. The relatively small portion may be less than 50% of the elements, less than 30% of the elements, less than 10% of the elements, less than 5% of the elements, less than 3% of the elements, or the like. In some cases, the list may be defined explicitly, such as by listing the elements directly. In other cases, the list may be defined implicitly and computed based on other properties of the attack.

Consider the following potential fault attack simulation models that are provided for the purpose of explanation.

One exemplary model may be:
total_attacks 100,000
each_attack_hits {5 10}
hits_window {50,000 51,000}
instance_list {aes_128/r7}

This model defines that there are between 5 to 10 hits in each attack (each_attack_hits), that occur in between cycles 50,000 and 51,000 (hits_window). The model also stipulates that the hits will occur only on the circuit elements that represent bits in the seventh round (r7) of an AES128 (AES stands for Advanced Encryption Standard, representative of a circuit design implementing encryption functionality and having a secret asset (e.g., encryption key)) module within the DUT. In this example, there is also an indication of how many attacks to simulate—100,000 attempts (total_attacks). This means that a simulator will simulate 100,000 fault attack attempts on the DUT. In each attack, there will be between 5 to 10 hits at cycles between 50,000 and 51,000 in circuit elements whose names have the prefix of “aes_128/r7”.

For example, a fault attack that may be generated based on the above model may be:
{(SEUF,aes_128/r7[127],50000,0)
(SEUF,aes_128/r7[124],50000,0)
(SEUF,aes_128/r7[126],50050,0)
(SEUF,aes_128/r7[123],50080,0)
(SEUF, aes_128/r7[120],50090,0)
(SEUF, aes_ 128/r7 [120],50999,0)}

This fault attack includes 6 hits of a same type (Single Event Upset Fault (SEUF)) in different signals associated with the aes_128/r7, during different cycles. Each hit has a time span of 0, meaning that the affect lasts only in the hit cycle and in the following cycles, the functionality returns to normal. It is noted that a hit may start at a certain cycle (t₁) and continue for a certain duration (len), which may be determined randomly or based on constraints. The hit may stop at cycle t₁+len. In some cases, the hit may be permanent, and continue until the end of the execution. As can be seen, in the same cycle (e.g., 50000) different signals are hit (aes_128/r7[124] and aes_128/r7[127]). Also, the same signal (aes_128/r7[120]) is hit in different cycles. This example is of a single multi-hit fault attack. According to the exemplary definitions above, a 1,000,000 such attacks may be generated for verification purposes.

Another example of a model may be:
total_attacks 1,000,000
each_attack_hits {5 10}
hits_window {150,000 160,000}
instance_list {aes_128/r8}

This model defines that there are between 5 to 10 hits in each attack (each_attack_hits), that occur in between cycles 150,000 and 160,000 (hits_window). The list of potentially attacked circuit elements in this case is signals associated with the eight round of AES (aes_128/r8).

Based on the fault attack simulation model, a plurality of multi-hit fault attacks are generated, and then simulated. The results of such simulation may be outputted to the user. In some cases, strobes may be defined to determine whether the attack was successful. The determination may be based on a comparison of the simulation with the fault and a simulation without the fault (also referred to as hit-free execution), and the difference therebetween. For example, if a certain signal has a different value than in the reference execution, it may be considered that data has leaked. In some exemplary embodiments, a failure strobe may be used to identify simulated executions in which a data leak via a side channel occurs or the attack was otherwise successful in providing the hacker with a desired outcome. A detection strobe may be used to identify simulated executions in which the on-chip detection mechanism identified the fault and reacted thereto (e.g., halting execution, taking error correction measures, or the like).

The output may indicate the number of simulations that were performed, the number or portion of simulations in which the attack was successful, the number or portion of simulations in which the attack was detected, or the like. In some cases, information on each simulation may be available. Aggregative information may be available and displayed to the user in different hierarchies. For example, a strobe-based division may be displayed, showing for each strobe, in how many simulations it was fired. A signal-based division may be displayed, showing how many successful attacks were related to each attacked signal, thereby drawing the user's attention to different areas of the DUT.

In some exemplary embodiments, different strobe types may be defined and used for either detection strobes or failure strobes. For example, a strobe of type “change” may fire if there's any change between the value of the monitored signal(s) in the simulated attack compared to the reference execution. Such a strobe may be useful as a failure strobe for sensitive signals that should never be affected by an attack. Additionally, or alternatively, a strobe of type “change_zero” or “change_one” may fire if the value changes to a specific value (e.g., one or zero). Such a strobe type may be useful on an output of 3-way lock-step. Additionally, or alternatively, a strobe of type “change_threshold” may fire if a threshold number of changes (any changes or changes to a specific value) are identified in the monitored signal(s). In some cases, the strobe may fire if the total number of changes in a set of monitored signals is over a predetermined threshold N. In other cases, the strobe may fire only if there are N changes or more in the same signal (e.g., even if the sum of changes in all signals is N but no single signal had an altered value in comparison to the reference execution in N cycles or more). In some exemplary embodiments, a strobe of type “delay” may fire if a value of the signal appears to be in delay with comparison to the reference execution. In some cases, the strobe may fire if the delay exceeds a threshold number of N cycles. Such a strobe may be useful for detecting delay attacks. In some exemplary embodiments, a strobe of type “deferential_power” may fire based on changes in voltage, power consumption, or the like with respect to a flop, a group of flops, an instance, or the like. In some cases, a change within a predetermined range, e.g., +/−N %, may be acceptable. A change that exceeds the range may trigger the strobe. The range may be symmetrical ([−N %, +N %], non-symmetrical ([−N %, +M %]), or the like. Additionally, or alternatively, the range may be defined using relative terms (+N %) or using absolute terms (+N).

In some exemplary embodiments, the generation of multi-hit fault attacks based on the fault attack simulation model may be performed using a pseudo-random generator, a theorem prover, a Constraint Satisfaction Problem (CSP) solver, a Boolean Satisfiability (SAT) solver, using brute force enumeration, or the like. The generation may be performed so as to provide concrete values to be used as the multi-hit fault attack, indicating which elements are hit and for each hit indicating which type of hit, at which cycle, for which time duration, or the like. The generation may be performed so as to create different multi-hit fault attacks that adhere to the fault attack simulation model. In some cases, the generation may create a random sample of multi-hit fault attacks that adhere to the fault attack simulation model from the population of all possible multi-hit fault attacks that adhere to the fault attack simulation model. In some exemplary embodiments, all multi-hit fault attacks may be generated and after all such attacks are available, their execution may be simulated. Additionally, or alternatively, generation and simulation may be performed together, such that after an attack is generated it may be simulated before all other attacks are generated. As an example, generation and simulation may be performed sequentially to generate an attack and simulate it prior to generating a new attack. As another example, after an attack is generated it may be added into a simulation queue to be dequeued therefrom and simulated once the simulator is available for performing such a simulation task. The generation may or may not continue to generate new attacks and add them into the queue even before the previous attack is simulated.

In some exemplary embodiments, the fault attack simulation model may be a pulse-based fault attack simulation model that models a pulse attack. The pulse attack may be, for example, a laser attack, an EM attack, or the like. The model may include a target location of the pulse attack. The target location indicates an area in the design of the circuit on which the pulse attack is focused. Based on the target location, the list of potentially attacked circuit elements may be computed.

For example, in case the design is a physical design, the target location may be provided using coordinates within the design (e.g., XY coordinates, XYZ coordinates, or the like). A radius of the pulse attack around the target location may be determined. The radius may be determined based on the properties of the attack. For example, the radius of a laser attack may be based on the intensity of the laser, based on the type of beam used, or the like. The radius may be, for example, 1 μm, 5 μm, 10 μm, or the like. The target location together with the radius may define a pulse-attacked region within the physical design. In some exemplary embodiments, based on the physical placement of circuit elements, the circuit elements that are located within the pulse-attacked region may be identified and determined as the list of potentially attacked circuit elements. Depending on the chip technology and the type of circuit elements, respective sizes of the circuit elements may be known and the number of and identity of the circuit elements may be determined. For example, in some cases, 100 gates may have a size of 100 nm. In some exemplary embodiments, the duration of the attack may be defined and such duration may affect the potential duration of the hits. Additionally, or alternatively, the type of pulse-based attack may indicate different types of hits on different types of elements (e.g., a laser attack may cause a flop to flip its value, but cause a gate to become stuck-at a specific value while an EM attack may cause a flop to become stuck at a specific value). In some cases, multi-pulse attacks may also be modeled. In such cases, multiple pulses may have different timing but share the same characteristics. Additionally, or alternatively, each pulse may be modeled individually. In some exemplary embodiments, the simulation may be performed based on an aggregation of the generated attacks based on the models of the different pulses.

In some exemplary embodiments, the design may be a logical design that does not have placement information of the elements in the circuit itself. As the logical design is devoid of physical locations of the elements, an approximation may be determined using logical proximity. The target location may indicate a target circuit element in the circuit, which is considered at the center of the pulse attack. Logical proximity from the target circuit element may be computed based on forward and backward reachability from the target circuit element. The reachability analysis may traverse the circuit, such as using Breadth-First Search (BFS) or any other search order, starting from the target circuit element, and identify all elements that are within a threshold logical distance from the target circuit element. For example, each wire that is traversed may be considered to increase the logical distance. Hence, all gates or flops directly connected to the target circuit element are within a logical distance of one, all gates or flops directly connected to elements that have a logical distance of one have a logical distance of two, and so forth. As another example, the logical distance may be increased when traversing a flop. Hence, all combinational logic between the target circuit element and between a next or previous flop may be considered as having a logical distance of zero, as well as the flop itself. Combinational logic that is directly connected to a flop having a distance of X may be considered as having an X+1 logical distance. In some exemplary embodiments, the reachability analysis may be a cycle-based distance. The cycle-based distance may be defined based on the number of cycles it takes information from the element to reach the target circuit element (for backward analysis) or vice versa (for forward analysis). It is noted that the above are exemplary logical distance metrics and other metrics may be used. In some exemplary embodiments, the list of potentially attacked circuit elements may include circuit elements that have a logical distance from the target circuit element that is below a threshold N. Such a computation may approximate related elements that are likely to be placed in proximity to the target circuit elements, thereby providing a reasonable approximation that can be used to identify vulnerabilities in the logical design prior to having a physical placement.

In some exemplary embodiments, the fault attack simulation model may be a timing-based fault attack simulation model that models a timing-based fault attack. A timing-based fault attack may be an attack that is aimed at manipulating the design to affect the timing of the circuit. The timing-based fault attack may be voltage glitching, clock glitching or the like. The design may comprise a combinational logic (e.g., implemented using gates) and sequential logic (e.g., implemented using flops). The data may be processed by the combinational logic and then latched by flops. The timing of the clock should allow sufficient time for the combinational logic to be completed and for the value at the inputs of the flops to be registered by the flop so as to be latched. Hence, one timing condition may be T_{clk}≥T_{comb}+Tₛₑₜᵤₚ, wherein T_{clk} is the timing of the clock, T_{comb} is the timing required for the combinational logic to be processed, and Tₛₑₜᵤₚ is setup time required for the flop. Such condition may be held with respect to all flops and their respective driving combinational logics. A timing-based fault attack may attempt to break such requirement and cause the circuit to violate this timing requirement. For example, a clock-based attack may attempt to manipulate the clock. In some exemplary embodiments, overclocking the circuit may decrease the time period of the clock and therefore increase its frequency. The timing available for the combinational logic is therefore reduced before the next latching edge, and as a consequence a wrong value may be latched. As another example, a voltage glitching attack may manipulate voltage provided to the gates, e.g., underpowering the gates. The effect of the voltage glitching may be altering and potentially increasing the delay of the gates. This delay may cause a violation of the timing requirement and to cause an incorrect value to be latched at the flops.

In some exemplary embodiments, when modeling a time-based attack, the potentially attacked circuit elements may consists of only flops and not gates, as the affect of the attack is to cause the flops to latch an incorrect value. In some cases, the potentially attacked flops may be selected based on power supply considerations. In voltage glitching, all gates that use a same power source may be affected by a voltage glitching targeting that power supply. Hence, the potentially attacked flops may include all flops that are driven by logic that is powered by the same power supply. Flops may be categorized into groups, each of which is associated with a different power supply. It is noted that in some cases, the same flop may be affected by gates that rely on different power supplies and therefore the flop may be included in more than a single group. Similarly, if the design utilizes more than a single clock, groups of flops that are based on different clock signals may be utilized based on which clock is being glitched. If the design utilizes a single clock, clock glitching potentially affects all flops of the design.

Additionally, or alternatively, the list of potentially attacked circuit elements may be determined based on a critical timing path in the circuit design. A critical timing path is the longest path or a most sensitive path within circuit design that determines the maximum operating speed of the circuit. In some cases, there may be several critical timing paths, such as the N longest/most-sensitive paths, and the disclosed subject matter may be applied accordingly. However, for simplicity, a single path is discussed without narrowing the scope of the disclosed subject matter. The critical timing path may be the path that takes the most time for a signal to propagate from the input of the circuit to the output, and thus sets the limit on the clock frequency that can be used for reliable operation. The critical timing path may include all components of the circuit that contribute to the propagation delay. In some cases, the model may be aimed at affecting elements along the critical timing path, as such element may be more susceptible than other to timing-based attack. In some exemplary embodiments, the list of potentially attacked circuit elements may be determined based on an estimated time budget of a combinational logic that drives the flops. In some cases, flops having an estimated time budget over a predetermined threshold may be included in the list, as such flops may be considered more susceptible to time-based attacks. Additionally, or alternatively, glitch timing may be modelled based on timing of the fault injection. Additionally, or alternatively, the type of hits in the model may be based on the attack. For example, voltage glitching may imply hits of types single event upset, bit event upset, or the like. Hits of type “stuck-at” may not be considered.

In some exemplary embodiments, the list of potentially attacked circuit elements may be determined based on secure asset information analysis of the design of the circuit. A static secure asset information analysis of the design may be utilized to classify different elements into Secure Asset Information (SAI), Driver of SAI (D-SAI), Load of SAI (L-SAI), Driver and Load of SAI (DL-SAI) and Unrelated to SAI (UR-SAI). In some cases, the list may be determined to include only loads of SAI (e.g., L-SAI and DL-SAI). The list may be determined to include only drivers of SAI (e.g., D-SAI and DL-SAI). In some exemplary embodiments, any element in UR-SAI may be ignored in the analysis as it cannot be used to expose the SAI. Hence, an exclusion rule may be utilized to exclude elements that are in UR-SAI. It is noted that the classification may be determined based on different elements that can be considered secure assets, together or in separate analysis, and hence an element may be considered in a different category for different secure assets. Additionally, or alternatively, the verification engineer may wish to focus the verification process on different aspects, such as to potential drivers into the secure assert, to potential load affecting by the secure asset, or the like. The verification engineer may define an exclusion rule to implement the desired focus.

In some exemplary embodiments, the fault simulation engine can take a fault attack simulation model (FAS_FAULT), a design, and generate a fault attack to be simulated that include multiple hits. For example: FAS_FAULT may define two hits: HIT1 and HIT2. The generated fault attack may indicate that HIT1 is a soft-error on flop_a at time T1 and HIT2 is a stuck-at-1 fault on net_123 at time T2 (T2>T1). The fault attack may be simulated using a hardware simulator. Simulation may start at T0, continue without fault until T1. At T1 the simulator may implement HIT1 by flipping the value of flop_a. Then the simulation will continue until T2, then it will change the netlist to create a permanent stuck-at-1 fault at net_123. Then it will continue until the end of the fault-simulation. In some exemplary embodiments a hit-free execution may be utilized to speed up the simulation to avoid computing computations that remain unchanged with respect to the hit-free execution trace, such is explained in detail in U.S. Pat. No. 10,025,895, entitled “Circuit Simulation Using a Recording of Reference Execution”, which is hereby incorporated by reference in its entirety. It is noted that the results of the simulation may be determined using strobes that are defined based on the hit-free execution trace which may be utilized as a reference execution or golden trace, even if such trace is not utilized as a means to speed up simulation.

One technical effect of the disclosed subject includes enabling pre-silicon security verification, which may enable shorter development time, and reducing re-design needed after the post-silicon phase is entered.

Another technical effect of the disclosed subject matter is providing an efficient manner of modeling of the potential attack, based on its related parameters, and focusing the verification efforts on relevant aspects. The disclosed subject matter may enable verification engineers to perform security verification using relatively significant smaller number of simulations or executions of the design. The tests used during the verification may be engineered and biased towards real-life potential attacks, assisting in providing sufficient coverage of the security verification at early stages of development.

Yet another technical effect may be to provide useful modeling of different potential attacks and enabling verification engineers to verify that specific attacks will not be useful against the circuit design. The modeling decreases the state space of the potential testing scenarios as the test space is limited to potential attacks. This is exemplified when addressing pulse-based attacks in the disclosed subject matter, which focuses on specific areas of the circuit design and affects such areas together in view of physical properties of the pulse being used (e.g., intensity, radius, etc.).

The disclosed subject matter may provide for one or more technical improvements over any pre-existing technique and any technique that has previously become routine or conventional in the art. Additional technical problems, solutions, and effects may be apparent to a person of ordinary skill in the art in view of the present disclosure.

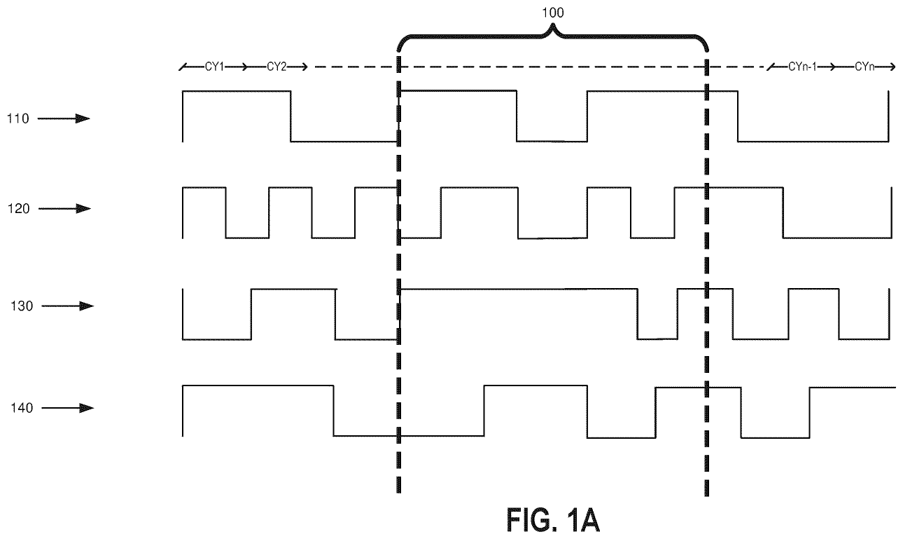

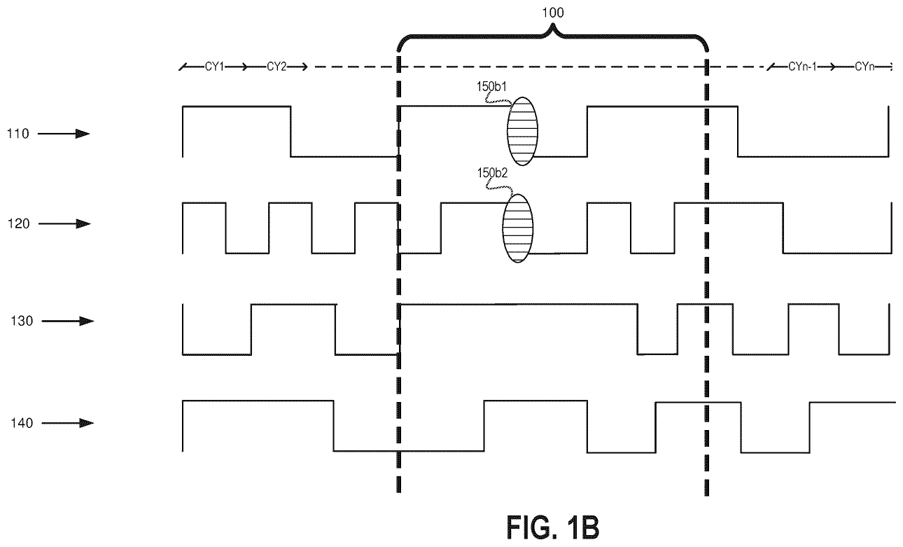

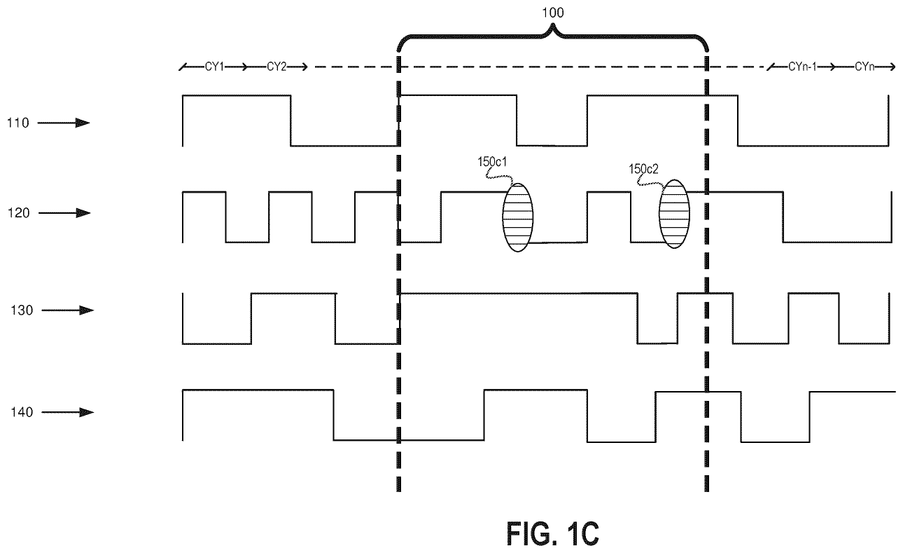

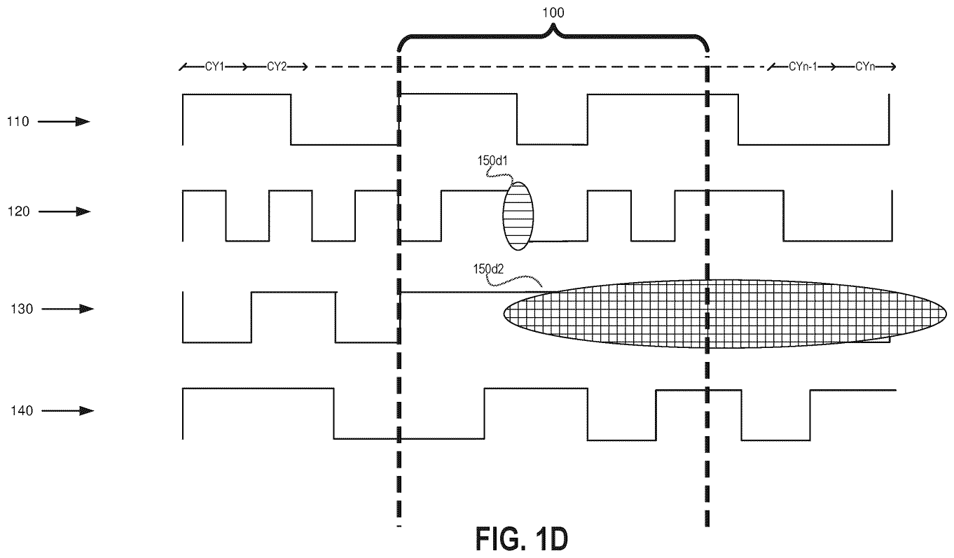

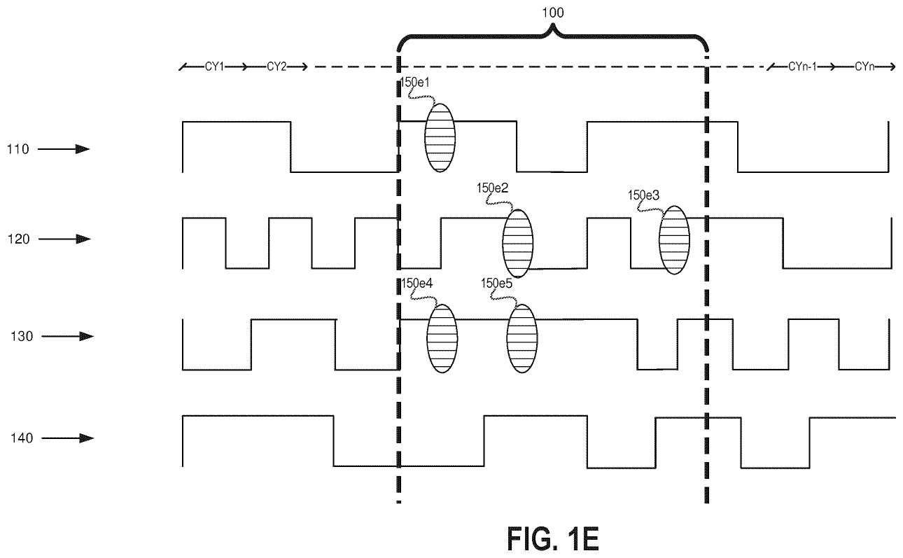

Referring now to FIG. 1A showing an illustration of a trace, in accordance with some exemplary embodiments of the subject matter. A trace exemplifying hit-free execution of the circuit is illustrated. Values of different signals (110-140) are illustrated using a waveform. The values are different in different cycles (CY₁, CY₂, . . . CYₙ). In some exemplary embodiments, a Time Window 100 in which the multi-hit fault attack is to be simulated may be defined. Accordingly, the multi-hit fault attack that is generated would include hits that occur within Time Window 100. In some exemplary embodiments, some of signals may be considered part of the list of potentially attacked circuit elements. For example, Signals 110-130 may be part of the list, and Signal 140 may be excluded therefrom. The multi-hit attack may be generated so as to cause hits only in signals that are part of the list. Not all signals are hit in the same fault attack. In each fault attack, there are multiple hits, either in the same signal, in different signals, in the same cycle, in different cycles, combination thereof, or the like. FIGS. 1B-1E illustrate potential multi-hit fault attack that may be generated.

In FIG. 1B, two single event upset hits (150b1, 150b2) may occur at two respective signals (110, 120) at the same cycle. FIG. 1C exemplifies two hits (150c1, 150c2) that occur in the same signal (Signal 120) at two different cycles. FIG. 1D exemplifies two different hit types. Hit 150d1 in Signal 120 is a single event bit flip that causes the value of Signal 120 to be one instead of zero for a single cycle. The remaining values are then computed based on this value and without taking into account such a hit once more (besides its effect on the value at the hit cycle). Hit 150d2, on the other hand, is a “stuck-at” hit that causes Signal 130 to be stuck at a specific value for the remainder of the execution. As can be seen, the affects of Hit 150d2 may remain even after Time Window 100. In some cases, the effects of multi-cycle fault may be limited to Time Window 100. Different types of hits may occur at the same cycle to different signals, may occur to the same signal at different cycles, or the like. FIG. 1E illustrates multi-hit fault attack that induces different hits in different signals (110, 120, 130), some of which occur in the same cycle (e.g., 150e1 and 150e4), some of which occur in different cycles (e.g., 150e1, 150e2, 150e3), some of which occur in the same signal (e.g., 150r4 and 150e5 occurring in Signal 130). It is noted that some hits may be synchronized so as that two flops/gates are hit simultaneously at the same cycles, while others are hit in a non-synchronized manner.

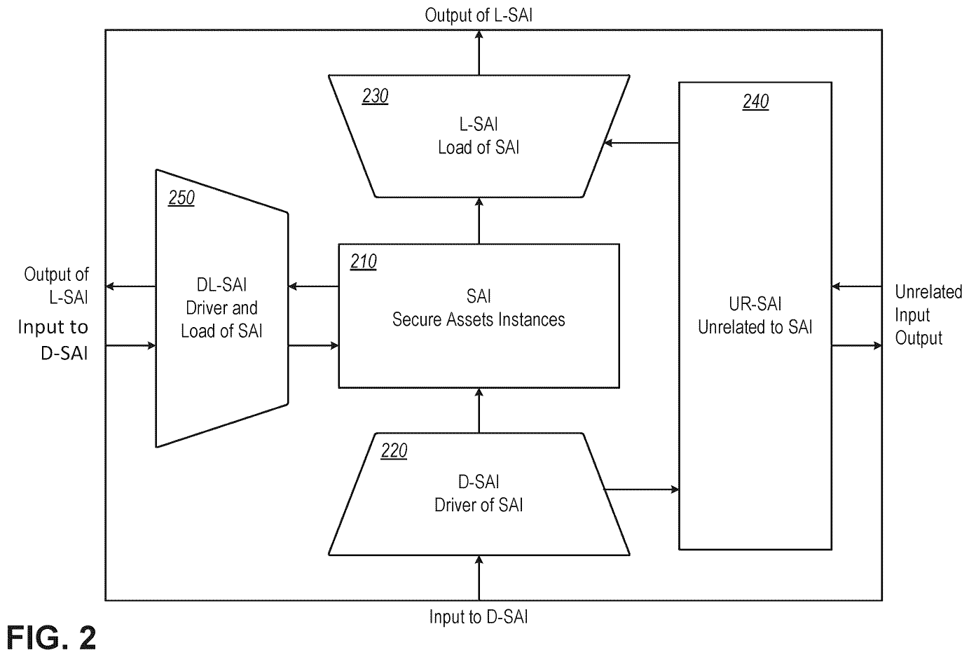

Referring now to FIG. 2, showing an illustration of SAI-based classification, in accordance with some exemplary embodiments of the subject matter.

FIG. 2 shows a logical classification of elements in a circuit design based on their respective interaction with a secure asset (SA). In some exemplary embodiments, Security Information Flow Analysis (SIFA) may be performed based on Secure Asset Information (SAI), in which given SAI as input, analysis can be performed, and visual output (e.g., color coded output) or different types secure asset of reports may be provisioned indicating gates and flops in the Design Under Test (DUT) based on different SIFA categorization. In some cases, SIFA may be performed a plurality of times, each time with respect to a different SAI. For example, there may different secure assets, such as but not limited to security modules, secure flops, secure instances, secure nets, secure and non-secure domain separation, or the like. The analysis may be performed to all secure assets together or separately for different groups of secure assets, thereby providing higher resolution level and more focused verification for each secure asset.

Based on the SAI, static analysis of the circuit design may be performed. Forward and backward traversals starting from all SAI nets and flops may be performed. During such traversal, gates and flops may be classified: L-SAI (the pure load of SAI) for gates/flops seen only in forward traversal, D-SAI (the pure driver of the SAI) for gates/flops seen only in backward traversal, DL-SAI (the mixed driver and load of SAI) for gates/flops seen in both forward and backward traversal, and UR-SAI (the unrelated elements to the SAI) for gates/flops not seen in either forward or backward traversal. The information may be presented to the user. In some exemplary embodiments, the classification may be utilized during fault attack simulation by focusing potential hits only on areas that may affect the SAI (e.g., not in URSAI). Additionally, or alternatively, strobes may be defined only on L-SAI or DL-SAI, as data leak can only manifest itself after the SAI was executed. Additionally, or alternatively, the verification engineer may be enabled to define exclusion rules based on the classification, and in view of her verification goals and insights.

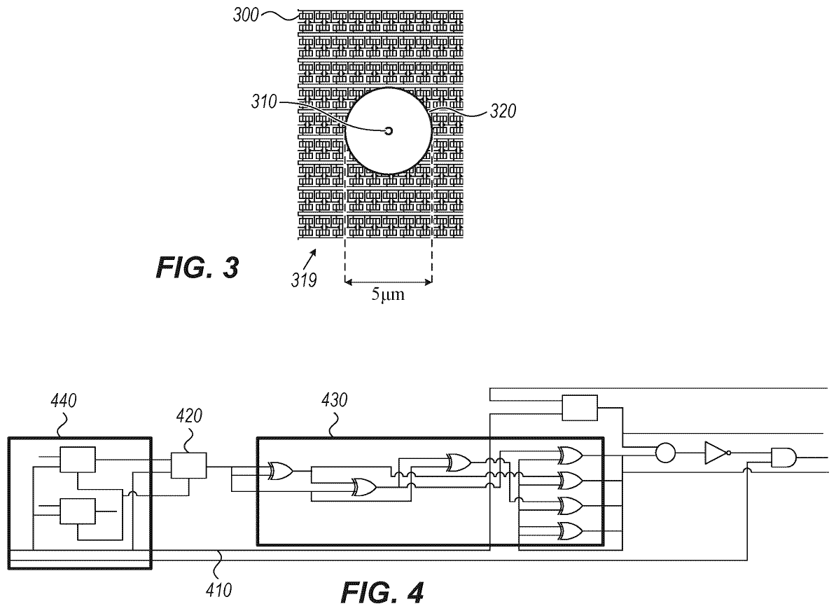

Referring now to FIG. 3 illustrating a laser attack in a physical design, in accordance with the disclosed subject matter. Such laser attack is an example of a pulse-based attack, and may be applicable to other pulse-based attacks, such as, for example and without limiting the scope of the present disclosure, EM attacks, x-ray attack, attack based on other radiation types, or the like.

Chip 300 may be a physical layout of a circuit design, having physical placement of the different circuit elements therein. A potential laser attack may be aimed at a Physical Location 310, which may be at the center of the laser beam used in the attack. In a physical chip, and since the laser beam is circular shape, the list of potentially attacked circuit elements may include all the gates inside a given circle, where this circle is centered where the laser beam is centered and has the radios of the laser beam. Other injection mechanisms may have different shapes or characteristics. Physical Location 310 may be given using XY coordinates, XYZ coordinates, given a name of an element that the laser is focused on, or the like. Based on Physical Location 310, the Pulse Attacked Region 320 may be determined. Region 320 may be determined based on Location 310 and in view of a Radius 315 of the attack, defining a circle having precise physical location.

In some exemplary embodiments, the modeling may be based on estimated size of the laser beam, and accordingly the number of different elements it can affect. The parameters of the model may include, for example, target attack location, e.g., specifying the location of the attack, or the center of the laser beam. The parameters may include a radius of the attack or the laser beam focus radius, e.g., impacting a group of gates and flops potentially influenced by the laser beam. The parameters may include a number of circuit elements attacked or actually influenced by the attack. This parameter may change with technology node, more gates in lesser technology node; as an example, at 22 nm, the number could be assumed to be about 100 gates; laser intensity-affects the number of gates influenced and may be connected with the radius (more radius, less intensity). The parameters may include a duration of the attack-how long the chip is irradiated, when does it start and when does it end. This parameter may influence the value duration to be modelled.

In some exemplary embodiments, Radius 315 of the attack may be determined. Radius 315 may be determined based on the pulse intensity property. The pulse intensity property may be selected by the verification engineer from a set of potential intensities that a hacker may use. The radius may be given in terms of μm, nm, or the like. In some cases, a laser attack may have a radius of 5 μm. In other cases, and with higher intensities, the radius may increase to 10 μm. The radius of EM pulses may be larger than that of a laser, e.g., 1 nm, 5 nm, 10 nm, 20 nm, or the like. Additionally, or alternatively, the pulse intensity may be left unspecified for the generator to determine. The generator may select the intensity, and accordingly, the radius, from a set of potential intensities. It is noted that the intensity may affect the radius as well as other aspects of the pulse-based attack. For example, given high intensity, irradiated elements may be more likely to malfunction and cause a “stuck at” hit than a single bit upset hit. This may be modeled within the pulse-based attack model by setting a different set of hit types to the potential hit (e.g., only “stuck-at” hits and not “bit flip” hits), by setting different probabilities to different hit types and biasing the hit types accordingly (e.g., “stuck-at” hits are twice as likely to occur than “bit flip” hits”), or the like.

Based on Pulse Attacked Region 320, and in view of the physical placement of all circuit elements, the list of potentially attacked circuit elements may be compiled. The list may include any element that is located within Pulse Attacked Region 320. In some exemplary embodiments, each affected gate/flop within the Pulse Attacked Region 320 can be extracted from the floorplan of the circuit design. In some exemplary embodiments, the list of potentially attacked circuit elements can be calculated as follows: add to the list each gate having X, Y physical location that is inside the Pulse Attacked Region 320. In some exemplary embodiments, the list may exclude elements, such as in view of any exclusion rule that may be applied.

Referring now to FIG. 4 that illustrates a laser attack in a logical design, in accordance with the disclosed subject matter. Such laser attack is an example of a pulse-based attack and may be applicable to other pulse-based attacks, such as, for example, and without limiting the scope of the present disclosure, EM attacks, x-ray-based attack, or the like.

In the absence of physical design, the final placement of circuit elements may not be known and the analysis performed with respect to the affected region cannot be performed. As an example, after synthesis, knowledge of actual gates in the chip exists, however, their placement may not yet be set and known. In some cases, the RTL design may be synthesized into gates. The list of potentially affected circuit elements may be determined based on instances, such as selecting elements from instances together, based on an assumption that the entire instance may be affected. Additionally or alternatively, logical proximity can be utilized to determine an approximated list of potentially attacked circuit elements. In some exemplary embodiments, logical proximity can be calculated. Logical proximity may start from a specific flop/gate that represents the center of the laser beam, and traverse a pre-defined logical distance. In some exemplary embodiments, the traversed distance may be different based on the traversed element (e.g., traversing a gate may be considered a shorter distance than traversing a flop). In some exemplary embodiments, the traversal may be performed from the target element forward and backward, such as based on the assumption that the laser is pointed to the target element and that a radius therefrom can include elements before and after the target element.

In some exemplary embodiments, a reasonable assumption is that elements that are connected will be placed relatively close to one another. Based on the logical design of the circuit, logical distance may be computed from a target circuit element that may be considered to be at the center of the attack. For example, Flop 420 may be considered at the center of the attack (e.g., the laser may be pointed at Flop 420 in an attempt to alter its behavior and the behavior in its vicinity). Backward and forward traversal may be performed while counting the logical distance from Flop 420. In some cases, all combinational logic may be considered within a same distance until reaching another flop. In other cases, each gate may increase the logical distance. Circuit elements that are located within a logical distance that is smaller than a threshold may be considered logically proximate to the element the attack is focused on (e.g., Flop 420). In some exemplary embodiments, the logical distance may be a cycle-based distance, indicating the number of cycles that it takes information from the element to reach the target circuit element or vice versa.

The list of potentially attacked circuit elements may be determined so as to include elements that are logically proximate to the target circuit element. The list may include, for example, the target circuit element, and all elements that have a logical distance of N or less therefrom. In some exemplary embodiments, the threshold used for defining the logical proximity may be based on the intensity of the pulse attack and the physical properties thereof. EM attacks may be considered as affecting larger areas than laser attacks, and therefore the threshold may be higher. As another example, as the intensity of the pulse increases, the logical proximity threshold may also increase.

In FIG. 4, Group 430 may include elements that are considered logically proximate to Flop 420 in view of forward traversal therefrom (Elements that are within the cone of influence of Flop 420 and within a logical distance that does not exceed the logical distance threshold). Group 440 may include elements that are considered logically proximate to Flop 420 in view of backward traversal therefrom (Flop 420 is in the cone of influence of such elements and within a logical distance that does not exceed the logical distance threshold).

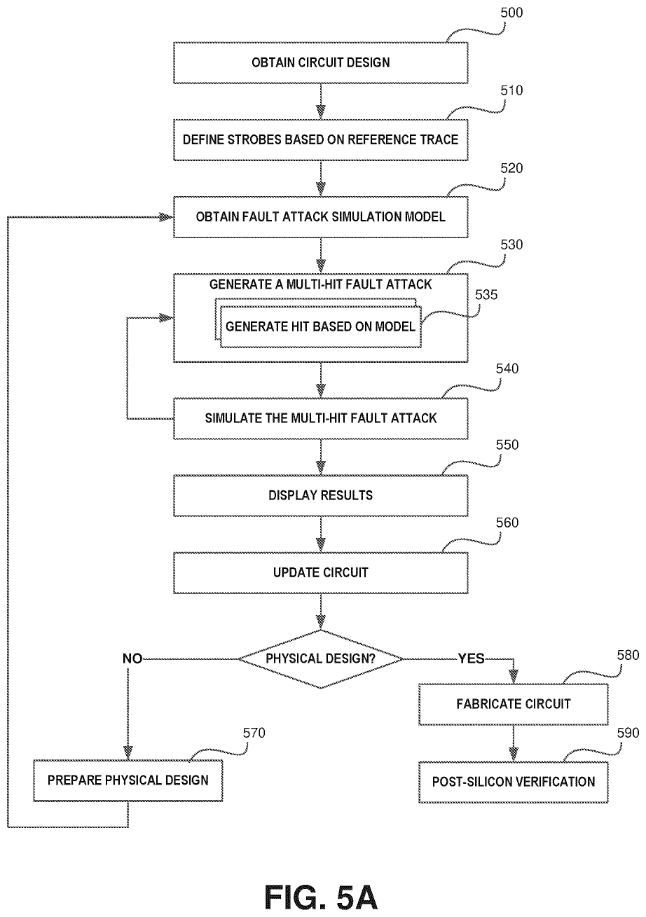

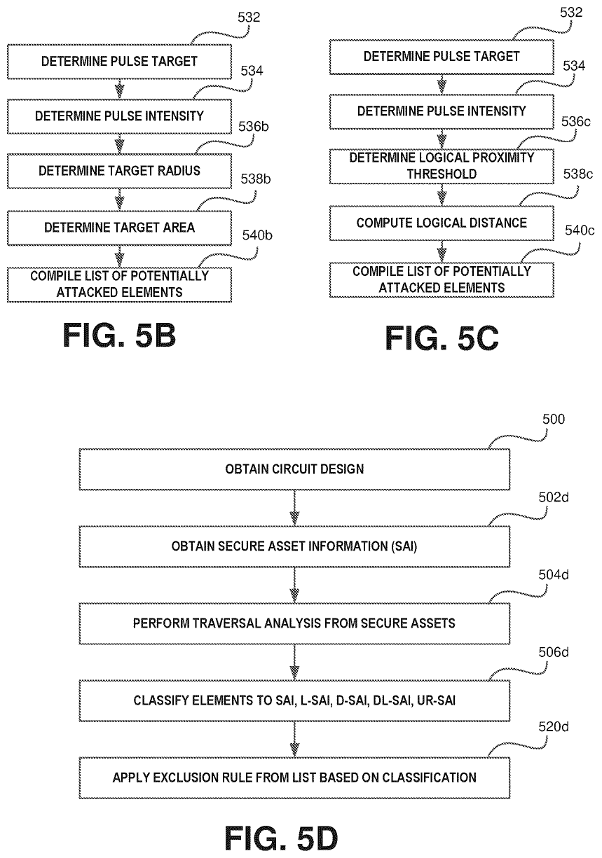

Referring now to FIG. 5A showing a flowchart diagram of a method in accordance with some exemplary embodiments of the disclosed subject matter.

In Step 500, a circuit design may be obtained. The circuit design may be a logical design, a physical design, or the like.

In Step 510, strobes may be defined. The strobes may be defined based on a reference hit-free execution. In some cases, a trace representing the hit-free execution may be available. If needed, a hardware simulator (not shown), may be used to simulate the design to obtain the reference trace. The strobes may be used to define whether the simulated attack is considered successful or not. The verification engineer may define failure strobes, representing situations in which the attack was able successful, such as when secure asset information leaks to a side channel that can be monitored by the hacker. Detection strobes may be defined to identify situations where detection mechanisms of the design are activated to prevent the malicious outcome of the attack.

In Step 520, a fault attack simulation model may be obtained. In some exemplary embodiments, fault attack simulation may be utilized to verify attack protection mechanism using fault simulation to attempt and simulate potential fault attacks, that may be implemented using different variety of attack vectors.

In some exemplary embodiments, a layered approach to attack modelling may be utilized. A HIT is a single fault (e.g., soft error/bit flip, stuck-at fault, bridging-fault or the like) in a single gate/flop occurring in a single cycle or a single time stamp. It is noted that a HIT may have a time-span of a single or multiple cycles, in which its affects remain. Additionally, or alternatively, a HIT can be permanent, once it starts it continues until the end of the simulation. A fault attack may model a single multi-hit attack, by combining several HITs. Attackers may combine or cause different faults as part of their fault attack. In some exemplary embodiments, many different fault attacks may be generated (530). The generation may be random, using some directing or biasing methods, based on modelling, or the like. Additionally, or alternatively, the generation can be directed, biased using CSP solvers, heuristics, or the like. Additionally, or alternatively, the user may provide explicit definition of every HIT in every fault attack. However, such explicit definition may not scale and may be used for specific examples and corner cases only. Due to domain knowledge of how attacks are being implemented, relevant modeling may be utilized as is disclosed in the present disclosure.

The fault attack simulation model obtained on Step 520 may model different potential multi-hit fault attacks that implement the same attack vector being modeled. In some cases, the same attack may yield different results, such as the laser attack that attempts to irradiate a specific location may affect different gates or flops each time a hacker attempts it. In some cases, the model may indicate a number of attacks to be attempted.

In Step 530, a single multi-hit attack is generated based on the model. Multiple hits are generated according to the model (535) and aggregated together to represent the fault attack. The generated attack indicates which hits should occur, at which cycles, for what duration, and on which circuit elements.

In Step 540, a simulator may be utilized to simulate the fault attack. The simulator may utilize a given input to simulate execution of the circuit design. Once a cycle in which a hit should be implemented (according to the generate multi-hit fault attack) is encountered, hit is implemented. The hit may be implemented by flipping the value of a relevant signal, by updating the netlist to change functionality of a signal (e.g., stuck-at functionality), or the like. During the simulation, values of the strobes may be monitored to determine whether the attack was successful. If a failure strobe is triggered, the attack is considered successful. Otherwise, it may be considered unsuccessful. If a detection probe is triggered, the attack is considered unsuccessful and simulation is halted. As a result, if the detection strobe is triggered prior to the failure strobe being triggered, the attack is considered unsuccessful even in a case where the continued simulation would result in the triggering of the failure strobe.

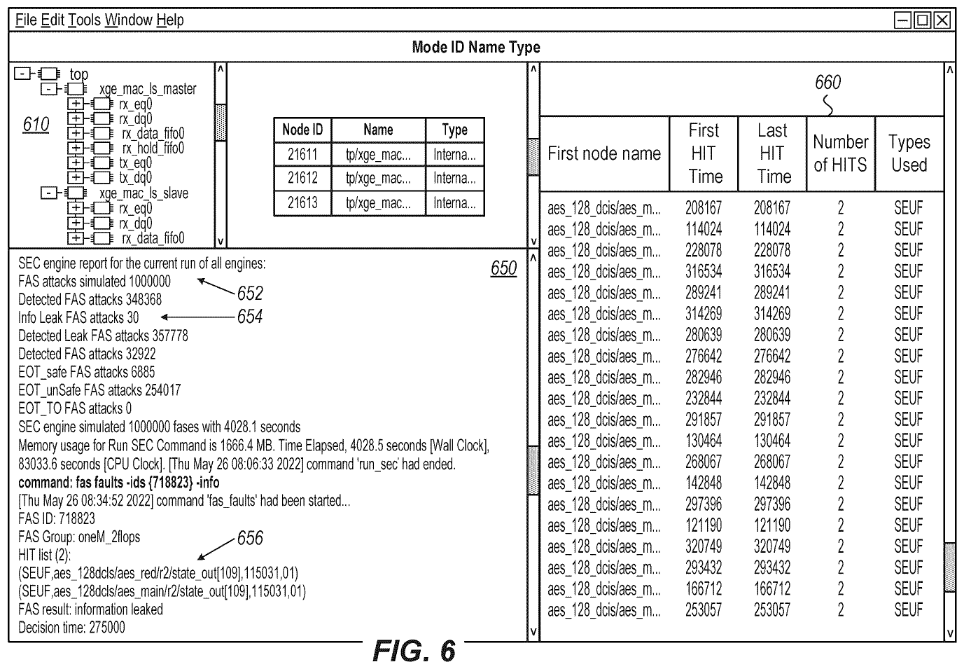

In Step 550, results may be displayed to the user. Non-limiting examples of outputs are exemplified in FIG. 6. It is noted that the output may indicate any combination of the following information: the number of simulated attacks, the number (or percentage) of successful simulated attacks, and the number (or percentage) of simulated attacks that were detected. The information may be given as overall information, or may be segregated based on different strobes (e.g., Strobe X1 was triggered Y1 times; Strobe X2 was triggered Y2 times), based on different hit elements (e.g., out of the Z attacks that involved a hit in element E, V attacks were successful), based on different hit cycles or sub-time frames (e.g., out of X1 attacks that caused a hit during sub-time frame F1, Y1 were successful), or the like. The results may be useful for an engineer to identify potential vulnerabilities in the design and to correct them (560).

If the design was logical design, a physical design may be designed (570), such as by defining a floorplan for the logical design. After the physical design is prepared, fault attack simulation may be performed again (520-560). In some cases, the fault attack models may be re-used. Additionally, or alternatively, the strobes may be reused or modified. In some exemplary embodiments, the second verification process may be limited to models that are affected by physical information, such as laser attacks. Other models that are not affected by the floorplan or physical placement may not be re-checked.

After the physical design is verified, the circuit may be fabricated (580), and post-silicon verification (590) may be performed. As the pre-silicon verification included fault attack verification, it is expected that in most cases, the post-silicon verification may detect no or little issues relating to fault attacks. Accordingly, the development time span may be reduced. Additionally, or alternatively, the amount of silicon resources required for the verification process may be reduced, as instead of using expensive and rare silicon resources of the fabricated design, regular CPUs may be used for the simulation process during the pre-silicon phase.

Referring now to FIG. 6 showing a screen showing the output of the fault attack simulation, in accordance with some exemplary embodiments of the disclosed subject matter. The user may select a specific instance, or sub-instance of elements in Hierarchy Dashboard 610. Textual output may be presented to show the execution log in Commands Dashboard 650. The log may indicate the results of each simulated attack, aggregated results, information relating to resources used (e.g., time, memory usage, CPU usage, or the like), number of faults that were marked as detected, number of faults that were marked as propagated, number of faults that were marked as dissipated, number of faults that were marked as safe end of trace, number of faults that were marked as unsafe end of trace, or the like. Pane 660 may display individual results for simulated executions of the DUT, such as simulated fault attacks. Each line in Pane 660 shows a different fault attack simulation, indicating for each simulated fault attack, the model that it implements (e.g., “FAS ID”), an indication of one or more of the hit elements (e.g., “First node name”), an indication of one or more cycles in which a hit was implemented (e.g., “First HIT Time”, “Last HIT Time”), number of hits (e.g., “number of HITS”), hit types (e.g., “Types Used”), or the like.

Commands Dashboard 650 is illustrated as indicating that 1,000,000 simulated fault attacks that were based on a single model were implemented (652). Out of the million simulations, in 30 information leak was detected (654). For a single simulated execution, Commands Dashboard 650 may indicate (656) the fault attack simulation model (e.g., “FAS ID”), the hits that were implemented (e.g., “Hit list”), and for each hit a type of hit (e.g., “SEUF”), element that was hit, a cycle in which the hit occurred, a duration of the hit, or the like. The outcome of the simulated attack may be indicated (FAS Result: information leaked). Resources utilized may also be indicated (e.g., CPU resources, memory resources, time resources, or the like).

The present disclosed subject matter may be a system, a method, and/or a computer program product. The computer program product may include a computer readable storage medium (or media) having computer readable program instructions thereon for causing a processor to carry out aspects of the present disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description, but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A method comprising:
obtaining a design of a circuit, wherein the circuit comprises circuit elements that include gates, flops and wires;
obtaining a fault attack simulation model defining characteristic of a multi-hit attack to be simulated in the circuit, the fault attack simulation model defines at least:
a number of hits during the multi-hit attack,
a time window in which the multi-hit attack is simulated, and
a list of potentially attacked circuit elements during the multi-hit attack, the list of potentially attacked circuit elements is a subset of the circuit elements;
automatically generating, based on the fault attack simulation model, a plurality of fault attacks adhering to the fault attack simulation, wherein each fault attack of the plurality of fault attacks includes a plurality of hits occurring during the time window and with respect to the list of potentially attacked circuit elements, wherein a number of hits in the plurality of hits corresponds to the number of hits defined by the fault attack simulation model;
for each fault attack of the plurality of fault attacks, simulating the fault attack on the design of the circuit, wherein said simulating is performed using a hardware simulator simulating the design of the circuit; and
outputting result of said simulating to a user.

2. The method of claim 1, wherein the fault attack simulation model further defining a type of fault occurring in a hit, wherein the type of fault is selected from a group consisting of: a single event upset, a stuck-at fault, and a bridging-fault.

3. The method of claim 1, wherein the fault attack simulation model is a pulse-based fault attack simulation model, wherein the pulse-based fault attack simulation model includes a target location of a pulse attack, wherein the target location of the pulse attack defines the list of potentially attacked circuit elements.

4. The method of claim 3, wherein the design is a physical design of the circuit that defines physical placement of the circuit elements, wherein the target location is a physical location in the physical design of the circuit, wherein the method further comprises:
determining a radius of the pulse attack;
determining a pulse attacked region based on the physical location and the radius of the pulse attack; and
identifying circuit elements that are within the pulse attacked region, whereby defining the list of potentially attacked circuit elements.

5. The method of claim 4, wherein the pulse-based fault attack simulation model includes a pulse intensity property, wherein said determining a radius of the pulse attack is determined based on a pulse intensity property.

6. The method of claim 3, wherein the pulse-based fault attack simulation model includes a pulse intensity property, wherein the number of hits during the multi-hit attack is determined based on the pulse intensity property.

7. The method of claim 3, wherein the design is a logical design, wherein the target location is a target circuit element that is selected from the circuit elements, wherein the method further comprises: determining the list of potentially attacked circuit elements based on logical proximity to the target circuit element.

8. The method of claim 7, wherein said determining the list of potentially attacked circuit elements comprises: performing forward and backward reachability analysis from the target circuit element.

9. The method of claim 7, wherein the forward and backward reachability analysis is performed based on cycle-based distance from the target circuit element.

10. The method of claim 3, wherein the pulse attack is at least one of: a laser attack and an electromagnetic (EM) attack.

11. The method of claim 3, wherein the pulse-based fault attack simulation model defines a first hit type for gates that are included in the list of potentially attacked circuit elements, wherein the pulse-based fault attack simulation model defines a second hit type for flops that are included in the list of potentially attacked circuit elements.

12. The method of claim 1, wherein the fault attack simulation model is a timing-based fault attack simulation model, wherein the timing-based fault attack simulation model is related to a timing-based fault attack that is configured to affect timing in which values of one or more flops are registered, wherein the list of potentially attacked circuit elements consists of the one or more flops.

13. The method of claim 12, wherein the timing-based fault attack is at least one of a voltage glitching attack and a clock glitching attack.

14. The method of claim 12, wherein the one or more flops that constitute the list of potentially attacked circuit elements is determined based on a critical timing path in the circuit design.

15. The method of claim 12, wherein the one or more flops that constitute the list of potentially attacked circuit elements is determined based on an estimated time budget of a combinational logic that drives the one or more flops.

16. The method of claim 1, wherein the list of potentially attacked circuit elements is determined based on an exclusion rule, the exclusion rule excludes elements based on secure asset information analysis of the design of the circuit.

17. The method of claim 16, wherein the secure asset information analysis comprises:
obtaining one or more secure circuit elements, the one or more secure circuit elements are circuit elements that are considered as secure assets; and
classifying the circuit elements based on respective relationship to the one or more circuit elements.

18. The method of claim 17, wherein said classifying comprises classifying each element as being at least one of:
a load of the one or more secure circuit elements;
a driver of the one or more secure circuit elements; and
unrelated to the one or more secure circuit elements.

19. The method of claim 16, wherein the secure asset information analysis is performed with respect to one or more secure circuit elements, wherein the exclusion rule excludes circuit elements that are classified as unrelated to one or more secure circuit elements.

20. The method of claim 1 further comprises:
obtaining one or more user instructions defining strobe signals, wherein the strobe signals are defined based on a change with respect to a hit-free execution of the design of the circuit;
wherein said simulating comprises evaluating values of the strobe signals; and
wherein the result of said simulating is determined based on the values of the strobe signals.

21. The method of claim 20, wherein the strobe signals comprise a failure strobe, wherein the failure strobe is indicative of a successful simulated attack, wherein the result of said simulating includes an indication of a number of successful simulated attacks out of a total number of attempted simulated attacks.

22. The method of claim 20, wherein the strobe signals comprise a detection strobe, wherein the detection strobe is indicative of a successful detection of a simulated attack by an on-chip detection mechanism, wherein the result of said simulating includes an indication of a number of successful detections of attempted simulated attacks.

23. A system comprising one or more processors and a memory,
said memory is configured to retain:
a design of a circuit, wherein the circuit comprises circuit elements that include gates, flops and wires; and
a fault attack simulation model defining characteristic of a multi-hit attack to be simulated in the circuit, the fault attack simulation model defines at least:
a number of hits during the multi-hit attack,
a time window in which the multi-hit attack is simulated, and
a list of potentially attacked circuit elements during the multi-hit attack, the list of potentially attacked circuit elements is a subset of the circuit elements;
at least one processor of said one or more processors is configured to automatically generate, based on the fault attack simulation model, a plurality of fault attacks adhering to the fault attack simulation, wherein each fault attack of the plurality of fault attacks includes a plurality of hits occurring during the time window and with respect to the list of potentially attacked circuit elements, wherein a number of hits in the plurality of hits corresponds to the number of hits defined by the fault attack simulation model; and
for each fault attack of the plurality of fault attacks, at least one processor of said one or more processors is configured to simulate the fault attack on the design of the circuit, wherein the simulation is performed using a hardware simulator simulating the design of the circuit.

24. A computer program product retaining non-transitory program instructions, which instructions, when executed by one or more processors, cause said one or more processors or portion thereof, perform:
obtaining a design of a circuit, wherein the circuit comprises circuit elements that include gates, flops and wires;
obtaining a fault attack simulation model defining characteristic of a multi-hit attack to be simulated in the circuit, the fault attack simulation model defines at least:
a number of hits during the multi-hit attack,
a time window in which the multi-hit attack is simulated, and
a list of potentially attacked circuit elements during the multi-hit attack, the list of potentially attacked circuit elements is a subset of the circuit elements;
automatically generating, based on the fault attack simulation model, a plurality of fault attacks adhering to the fault attack simulation, wherein each fault attack of the plurality of fault attacks includes a plurality of hits occurring during the time window and with respect to the list of potentially attacked circuit elements, wherein a number of hits in the plurality of hits corresponds to the number of hits defined by the fault attack simulation model;
for each fault attack of the plurality of fault attacks, simulating the fault attack on the design of the circuit, wherein said simulating is performed using a hardware simulator simulating the design of the circuit; and
outputting result of said simulating to a user.
